(19) United States
(12) Patent Application Publication
(10) Pub. No.: US 2007/0010703 A1
(43) Pub. Date: Jan. 11, 2007

(54) Airfoam force-prevention medical transport mattress

(75) Inventors: Shetal Shah, Great Neck, NY (US); Martha Caprio, North Flushing, NY (US)

Correspondence Address: DARBY & DARBY P.C., P. O. BOX 5257, NEW YORK, NY, 10150-5257, US

(73) Assignee: New York University, New York, NY (US)

(21) Appl. No.: 11/176,582

(22) Filed: Jul. 6, 2005

(51) Int. Cl. A61G 11/00

(52) U.S. Cl. 600/22

(57) ABSTRACT

A medical transport system and methods for assembling and using the medical transport system to reduce impacts and forces to a patient during transit. One embodiment of the medical transport system includes a support frame, an incubator and a transport mattress. The transport mattress includes memory foam on either or both the top and bottom surfaces of the transport mattress. The method of assembly includes placing the transport mattress inside the incubator and above the support frame. The method of use includes the steps of placing a patient inside the incubator and positioning the patient above the support platform and on the transport mattress to thereby reduce impacts and forces to a patient during transport. A second embodiment of the medical transport system includes a support frame, straps for securing a patient to the medical transport system and a transport mattress including memory foam on either or both the top and bottom surfaces of the transport mattress.

### FIELD OF THE INVENTION

The present invention relates generally to medical transport devices and more specifically to medical transport devices for infants to reduce forces and impact to a patient.

### BACKGROUND OF THE INVENTION

Medical emergencies frequently require that patients be transported to hospitals or offices where they may be treated. In the case of infant patients, the transport can be harmful because of the infant's vulnerability. In an effort to protect the patient, hospitals and ambulances frequently have transport systems designed to provide safe transportation environments for the patient. Conventional transport systems contain at least an incubator and a mattress. The incubator is used to ensure a safe environment for the patient and the mattress provides patient comfort and protects the patient from directly contacting the floor of the incubator.

Under smooth traveling conditions these transport systems are sufficient to protect the patient from common hazards. However, rough roads can result in conditions that are beyond that which conventional transport systems can protect. In many cases the impulses applied to the patients due to bumps in the road are too great for the conventional transport mattress to dampen. Frequently the impulses are sufficient to allow the patient's head to bump against the floor of the incubator. This bumping can cause hospital transfer-related morbidity, including intraventricular hemorrhage, which can lead to cerebral palsy later in life.

### SUMMARY OF THE INVENTION

The present invention is for an improved medical transport system including a force-prevention medical transport mattress. The transport mattress includes a material, such as memory foam, which reduces impulses to supported objects. The transport mattress reduces concussive forces transmitted to a patient due to bumpy road conditions. The transport mattress further prevents transfer-related morbidity resulting from impulse forces sustained during transit. The mattress provides safe transport for the patient.

In accordance with one aspect of the invention there is provided a medical transport system including a generally flat support frame; an incubator on the support frame; and a transport mattress having a top surface, a bottom surface and a layer of memory foam adjacent at least one of the respective top and bottom surfaces, wherein the medical transport mattress is inside the incubator and supported by the support frame.

In accordance with another aspect of the invention there is provided a medical transport system including a generally flat support frame; a transport mattress having a top surface, a bottom surface and a layer of memory foam adjacent at least one of the respective top and bottom surfaces; and at least one strap for securing a patient to the medical transport system, wherein the transport mattress is above the support frame.

In accordance with another aspect of the invention there is provided a method for using the medical transport system. The method including providing a memory foam mattress within an incubator, placing the patient inside the incubator and positioning the patient on the top surface of the mattress, wherein the patient is supported by the support frame.

In accordance with yet another aspect of the invention there is provided a method for assembling the medical transport. The method including positioning the incubator on the support frame and placing the transport mattress inside the incubator for receiving a patient.

These and other aspects, features, and advantages of the present invention will be apparent from the accompanying Drawings and Description of the Preferred Embodiment.

### BRIEF DESCRIPTION OF THE DRAWING

FIG. 1 is a perspective view of an embodiment of a medical transport system according to the invention;

FIG. 2 is a perspective view of an alternative embodiment of a medical transport system according to the invention; and

FIG. 3 is a perspective view of a transport mattress of the medical transport system.

### DESCRIPTION OF THE PREFERRED EMBODIMENT

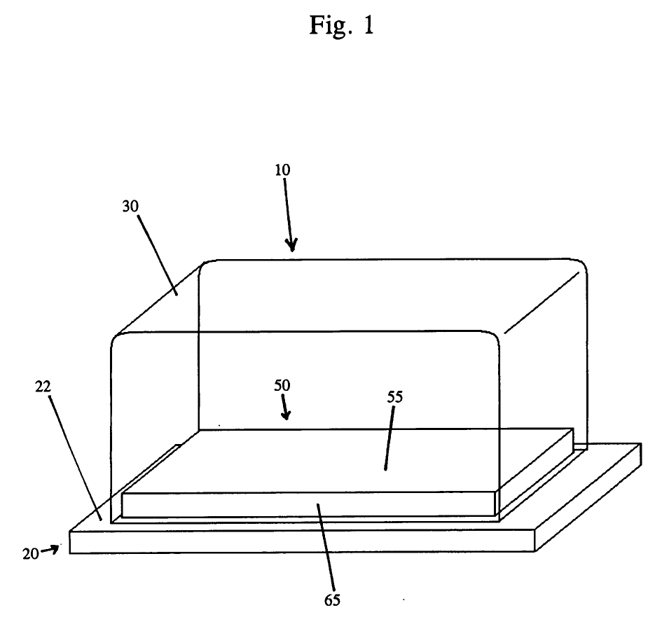

A medical transport system 10 as shown in FIG. 1 includes a support frame 20, an incubator 30 and a transport mattress 50. The support frame 20 includes a top surface 22. The incubator 30 is located above the top surface 22 of the support frame 20. The transport mattress 50 includes a memory foam to reduce injury to a patient and is situated inside the incubator 30 above the support frame 20.

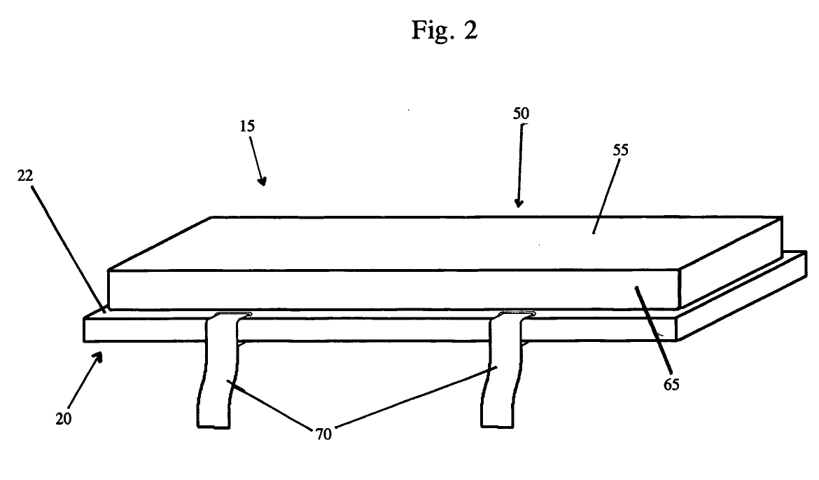

An alternative medical transport system as shown in FIG. 2 includes a support frame 20, a transport mattress 50 and straps 70 for securing a patient to the medical transport. The support frame 20 includes a top surface 22. The transport mattress 50 includes a memory foam to reduce injury to a patient and is situated above the support frame 20.

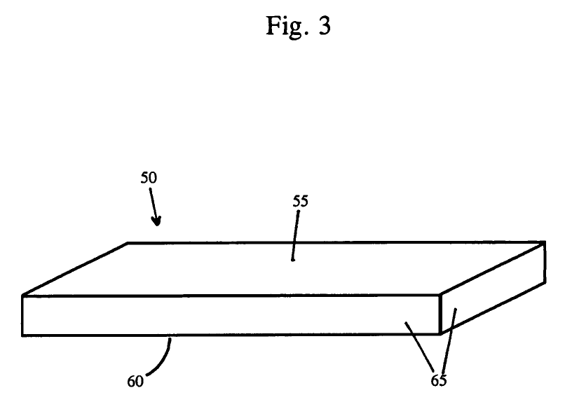

In one embodiment of the present invention, as shown in FIG. 3, the transport mattress 50 is rectangular in shape and has a top surface 55, a bottom surface 60, and four vertical surfaces 65 joining the top surface 55 and bottom surface 60. In another embodiment (not shown) the transport mattress may be oval in shape and have a top surface a bottom surface and a single vertical surface. The transport mattress may also have an outer covering made of a polyester knit with urethane coating or any other material known in the art to allow easy cleaning.

Preferably, the transport mattress 50 may be securable with respect to the support frame 20. The transport mattress 50 may be secured to the support frame using straps or fasteners. Alternatively, the bottom surface 60 and/or the vertical surface(s) 65 of the transport mattress 50 and the incubator 30 may include Velcro® to secure the mattress. Alternatively, any other method known in the art of securing a mattress to another structure may be used.

While the invention has been described in connection with certain preferred embodiments thereof it is not limited to such embodiments but rather is defined by the scope of the claims appended hereto. Additionally, while the invention has been described in connection with the transport of patients between medical facilities, the invention may also be used to transport patients within a single medical facility.

What is claimed is:

1. A medical transport system comprising:
an incubator;
a support frame; and
a transport mattress having a top surface, a bottom surface and at least one vertical surface, the transport mattress including memory foam adjacent at least one of the respective top and bottom surfaces.

2. The medical transport system of claim 1 wherein the transport mattress includes a cleanable coating over at least one of the respective top and bottom surfaces.

3. The medical transport system of claim 1 wherein the transport mattress includes an attachment for attaching the mattress to the support frame.

4. A medical transport system comprising:
a support frame;
a transport mattress having a top surface, a bottom surface and at least one vertical surface, the transport mattress including memory foam adjacent at least one of the respective top and bottom surfaces; and
at least one strap for securing a patient to the medical transport system.

5. The medical transport system of claim 4 wherein the transport mattress includes a cleanable coating over at least one of the respective top and bottom surfaces.

6. The medical transport system of claim 4 wherein the transport mattress includes an attachment for attaching the mattress to the support frame.

7. A method for safely transporting a medical patient comprising the steps of:
placing a transport mattress having a top surface and a bottom surface and including memory foam adjacent at least one of the respective top and bottom surfaces on a-support frame; and
placing a patient on the mattress inside an incubator.

8. A method of assembling a medical transport system comprising the steps of:
positioning a transport mattress inside an incubator and above a support frame, the transport mattress having a top surface and a bottom surface and including memory foam adjacent at least one of the respective top and bottom surfaces; and
placing an incubator above the support frame.
